(19) United States
(12) Patent Application Publication
(10) Pub. No.: US 2010/0037781 A1
(43) Pub. Date: Feb. 18, 2010

(54) ATTACHMENT FOR A CUP

(75) Inventors: David Wilfried Magda Pas, Antwerp (BE); Matthias Stein, Leatherhead (GB); Helen Jane Woolley, Bedford (GB); Frederik Wouters, Rupelmonde (BE)

Correspondence Address: UNILEVER PATENT GROUP, 800 SYLVAN AVENUE, AG West S. Wing, ENGLEWOOD CLIFFS, NJ, 07632-3100, US

(73) Assignee: CONOPCO, INC., D/B/A UNILEVER, Englewood Cliffs, NJ (US)

(21) Appl. No.: 12/541,270

(22) Filed: Aug. 14, 2009

(30) Foreign Application Priority Data
Aug. 18, 2008 (EP) EP08162498

(51) Int. Cl. A47J 31/44; A47G 19/22

(52) U.S. Cl. 99/290; 220/713

(57) ABSTRACT

Disclosed is an attachment (100) for a cup (200) having a body (210), a base (220) and a mouth (230) delimited by a rim (240). The attachment comprises a chamber (110) for holding an infusion bag (300) and comprising a wall (111) delimiting a cavity (112) for receiving the infusion bag (300) and a mouth (113) for allowing the infusion bag (300) to pass into the cavity (112). The attachment further comprises an element (120) for suspending the chamber (110) within the cup (200) such that at least a portion of the mouth (113) of the chamber (110) is below the rim (240) of the cup (200). The element (120) and chamber (110) are arranged such that when the chamber (110) is suspended in the cup (200), liquid (400) cannot pass between the cup and the chamber when the cup is substantially full.

### TECHNICAL FIELD OF THE INVENTION

The present invention relates to attachments for cups, especially disposable cups, in which infused liquid beverages are dispensed. In particular, the present invention relates to such attachments which allow for the safe and convenient preparation of infusion beverages and avoid the need to remove and dispose of the infusion bag before consuming the beverage.

### BACKGROUND OF THE INVENTION

Many liquid beverages are made by infusion. These include tea beverages which may be made by infusing green, black, white or oolong teas derived from the plant Camellia sinensis or by infusing other plant materials to give the so-called herbal teas and coffee beverages which are made by infusing roasted and ground coffee beans or by infusing processed coffee products such as instant coffee powders or granules. The preferred liquid beverages are tea beverages.

Liquid beverages such as those sold to the consumer in an out-of-home environment (e.g. fast food or take-away establishments or catering situations such as canteens in the workplace) are often served in a container which has a lid to minimise spillage. The lid may be provided with a drinking aperture through which the consumer drinks the beverage. Such beverages are often prepared by immersing an infusion bag in water in the container and allowing the contents of the infusion bag to infuse for sufficient time to achieve the strength of beverage required by the consumer.

In this specification the term “infusion bag” is intended to mean a porous bag which contains an infusible material from which a liquid beverage is made by infusion. Typically the infusion bag will be a tea bag.

To enhance the infusion many consumers agitate the infusion bag in the water. If the infusion bag is provided with a string and tag, the user may use the string to move the infusion bag up and down through the water in the container. After a sufficient infusion time the user must remove the infusion bag from contact with the water to prevent further infusion. This can be a messy operation as the infusion bag when removed from the water still has water contained in it which can drip as the infusion bag is moved. The above-described agitation and removal of the infusion bag is made much more difficult if the container is provided with a lid which must be removed before the agitation and bag removal can take place. Removing the lid, and optionally replacing it before the beverage is consumed increases the risk that the beverage will be spilled. As the beverage may be hot this increases the chance of the consumer being hurt by the hot liquid and of the liquid being spilled onto the consumer's clothing or into the surroundings.

WO 2004/026722 (Unilever) discloses containers which have a lid wherein the lid is provided with an opening having a first portion which is capable of gripping the string of an infusion bag and a second portion through which the string of the infusion bag can move into and out of the container. This arrangement allows for the consumer to move the infusion bag within the container by pulling the string through the second portion of the opening and then to lock the infusion bag in a raised position, thus stopping the infusion process, by gripping the string in first portion of the opening.

Whilst the lids and containers disclosed in WO 2004/026722 ensure that the consumer can be supplied with an infused liquid beverage in a safe and convenient manner and avoid the need to remove and dispose of the infusion bag before consuming the beverage, they have certain drawbacks. From a manufacturing point of view, threading of the string and tag through the opening in the lid is difficult to automate. From a user's point of view, locking the infusion bag in a raised position does not always guarantee that the infusion process will be completely stopped or that the infusion bag will not interfere with the dinking process. For example, depending on how high the bag is raised and/or how the beverage moves within the container during drinking, the bag may re-contact the beverage and/or obstruct the drinking aperture.

Thus we have developed a means to allow for supply to a consumer of an infused liquid beverage in a safe and convenient manner whilst avoiding the need to remove and dispose of the infusion bag before consuming the beverage, but without one or all of the abovementioned drawbacks.

### SUMMARY OF THE INVENTION

In a first aspect, the present invention provides an attachment for a cup having a body, a base and a mouth delimited by a rim, the attachment comprising:
a chamber for holding an infusion bag and comprising a wall delimiting a cavity for receiving the infusion bag and a mouth for allowing the infusion bag to pass into the cavity; and
an element for suspending the chamber within the cup such that at least a portion of the mouth of the chamber is below the rim of the cup;
   wherein the element and chamber are arranged such that when the chamber is suspended in the cup, liquid cannot pass between the cup and the chamber when the cup is substantially full.

In a second aspect, the present invention provides a container comprising the attachment of the first aspect and a cup wherein the chamber of the attachment is suspended within the cup. Preferably the container also comprises a lid covering the mouth of the cup.

Suspending the chamber in the cup such that at least a portion of the mouth of the chamber is below the rim of the cup allows for easy passage of the infusion bag from the body of the cup into the chamber. Preferably substantially all of the mouth of the chamber, more preferably the entire mouth of the chamber, is below the rim of the cup, as this facilitates even easier passage of the infusion bag into the chamber. Preferably the arrangement of the element and chamber allows passage of the infusion bag from the body of the cup into the cavity of the chamber without removing the infusion bag from the cup.

Arrangement of the element and chamber such that when the chamber is suspended in the cup, liquid cannot pass between the cup and the chamber when the cup is substantially full, allows for complete cessation of the infusion process by depositing the infusion bag in the chamber. A preferred arrangement to achieve this end is wherein when the chamber is suspended in the cup the wall of the chamber extends substantially vertically downwards from the mouth of the chamber as this allows for the cavity to be below the mouth of the chamber. Additionally or alternatively, it is preferred that the arrangement of the element and the chamber is such that the liquid is not in contact with the mouth of the chamber when the cup is substantially full. It is also preferred that the wall is substantially impermeable to water, more preferably the wall is impermeable to boiling water. By “substantially full” is meant that the volume of liquid in the cup is at least 70% (v/v) of the brimful capacity of the cup, more preferably at least 75%, more preferably still at least 80% and most preferably from 85 to 97%. It is additionally preferred that when substantially full, the level of liquid in the cup is at least 70% of the total height of the cup, more preferably at least 75%, and most preferably from 80 to 95%.

The element preferably comprises a first portion which extends from the chamber over the rim of the cup, as this is a convenient means of suspending the chamber in the cup. However, in order that a flange of a lid may still be secured over the rim, it is preferred that the first portion of the element is shaped to pass over the rim of the cup without protruding more than 2 mm above the rim, more preferably without protruding more than 1 mm, more preferably still without protruding more than 0.5 mm and most preferably protruding between 0.01 and 0.2 mm.

Additionally or alternatively, the first portion of the element may comprise a groove or slit shaped to allow a string of an infusion bag to slide therethrough as such a groove or slit allows for a user to move the infusion bag within the cup even when a lid is fitted thereto. Also, the presence of a groove or slit in the first portion facilitates drawing the infusion bag into the chamber of the attachment by a user pulling the string away from the body of the cup, without removing the infusion bag from the cup. In this respect it is additionally or alternatively preferred the string of the infusion bag extends from the infusion bag over the mouth of the chamber and over the rim of the cup, more preferably over the rim of the cup via the groove or slit in the first portion of the element. It will be appreciated that in these arrangements it is not necessary for the string to pass through an aperture in a lid (when present).

In a preferred embodiment, the element comprises an annular portion shaped to receive the body of the cup, as this allows for stable suspension of the chamber in the cup. Preferably also, the chamber is hingedly attached to the annular portion of the element, as this allows for easy assembly of a container by nesting the body of the cup within the annular portion and then pivoting the chamber about the hinge to suspend the chamber within the cup. To avoid the need for any special means for securing the annular portion to the cup (such as adhesive etc.), it is preferred that the internal diameter of the annular portion is intermediate between the diameter of the base of the cup and the diameter of the mouth of the cup, thus allowing the cup to fit snugly within the annular proportion and preventing the cup slipping through the annular portion in use.

We have found that the attachment of the present invention (or a part thereof) may conveniently serve a secondary function to provide a means by which a user may conveniently and safely grip and manipulate the container. The attachment (or a part thereof) may additionally or alternatively serve to thermally insulate the container. Thus in a preferred embodiment the attachment comprises a hand grip. In one embodiment the hand grip is a section of the annular portion of the element, more preferably a section of the annular portion which is textured. It is especially preferred that the section of the annular portion forming the hand grip is a vertically elongate insulating sleeve. Additionally or alternatively, the hand grip may be a handle arranged to extend outwardly from the cup when the chamber is suspended therein.

### BRIEF DESCRIPTION OF THE DRAWINGS

The present invention will now be further described by reference to the drawings in which:

FIG. 1 is a projection of an attachment according to an embodiment of the invention.

FIG. 2 is a sectional view of the chamber of the attachment of FIG. 1.

FIG. 3 is a projection of a container comprising the attachment of FIG. 1.

FIG. 4 is a sectional perspective view of the container of FIG. 3 in use.

FIG. 5 is a perspective view of a container according to another embodiment of the invention.

FIG. 6 is a perspective view of the container of FIG. 5 additionally comprising a lid.

### DETAILED DESCRIPTION

The present invention will now be further described by reference to the following preferred embodiments.

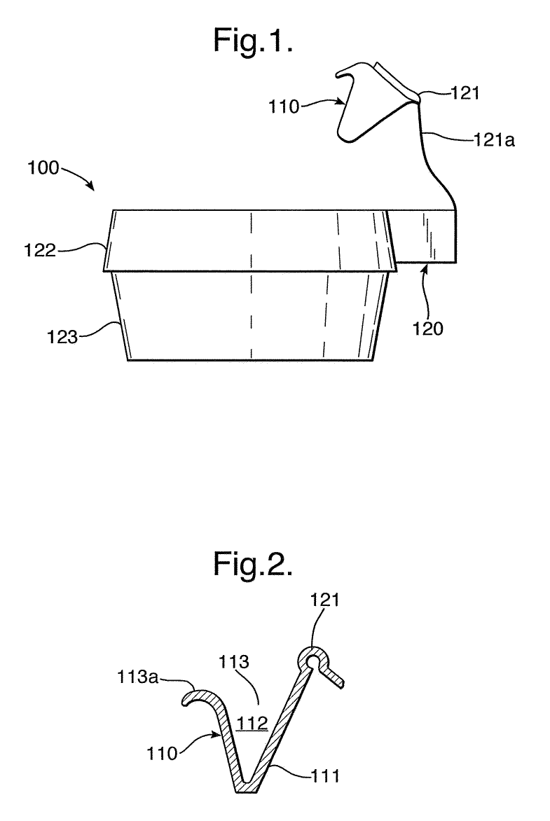

A first embodiment of the invention is illustrated in FIGS. 1 to 4. A container (1) comprises a cup (200) and an attachment (100).

The cup (200) has a circular base (220) and a circular mouth (230) delimited by a rim (240) which may be in the form of a bead. The mouth (230) of the cup has a larger diameter than that of the base (220) and thus the body of the cup (210) has a frusto-conical shape, tapering towards the base (220). The cup is preferably a standard disposable cup used in the food service industry. For example, the cup may be a standard 8 Oz cup wherein the mouth (230) has a diameter of about 80 mm or a standard 12 Oz cup wherein the mouth (230) has a diameter of about 90 mm.

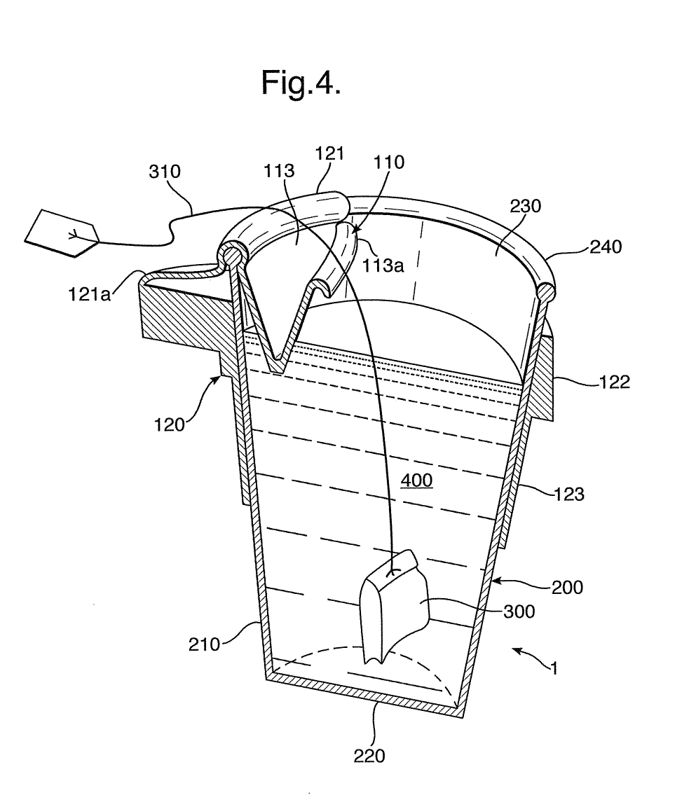

FIG. 1 illustrates the attachment (100) before assembly of the container. The attachment comprises a chamber (110) and an element (120). As best seen in FIGS. 2 and 4, the chamber comprises a wall (111) delimiting a cavity (112) and a mouth (113). The wall (111) extends away from the mouth in a generally downwards direction and tapers towards the base of the chamber (110). The mouth (113) has along its front edge, a lip (113a) which is curved to allow easy passage of an infusion bag (300) into the cavity (112). Extending away from the remaining edges of the mouth (113) is a first portion (121) of the element (120). The first portion (121) is shaped to receive a section of the bead of the rim (240) of the cup (200).

The element (120) further comprises an annular portion (122) which has an internal diameter intermediate between that of the mouth (230) and the base (220) of the cup (200) and thus is shaped to receive the body (210) of the cup therein. The annular portion comprises a vertically elongate insulating sleeve which serves as a hand grip (123) for the assembled container. Extending between the first portion (121) of the element (120) and the annular portion (122) thereof is a hinge (121a) formed of a flexible strip of material.

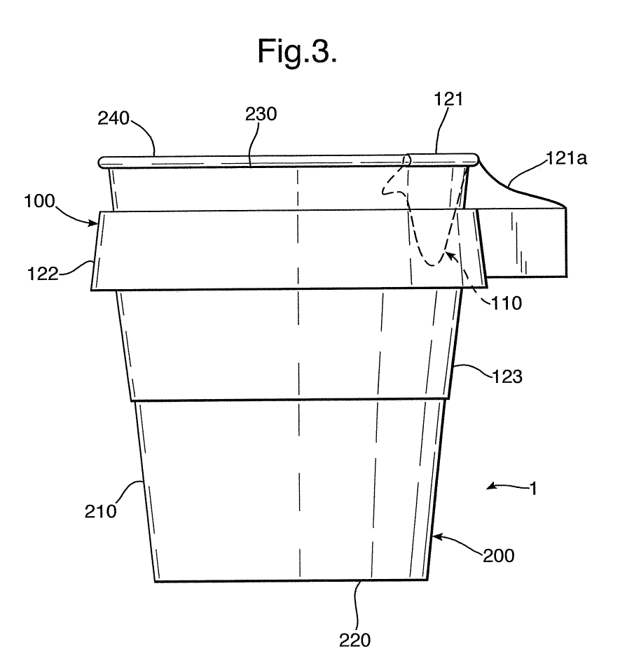

In order to assemble the container (1) shown in FIG. 3, the chamber (110) is first moved about the hinge (121a) to a position outside of the circumference of the annular portion (122). The base (220) of the cup is then located concentrically within the annular portion (122) and the annular portion slid towards the mouth (230) of the cup until, owing to friction between the body (210) of the cup and the annular portion (122), the cup is snugly nested within the annular portion (122). The chamber (110) is then moved about the hinge (121a) towards the mouth (230) of the cup until the rim (240) of the cup is received by the first portion (121) of the element (120) and the chamber (110) is suspended within the cup (200). It will be appreciated that in this arrangement the mouth (113) of the chamber (110) (and especially the lip (113a) thereof) is below the level of the rim (240) of the cup.

As can be seen from FIG. 4, in use an infusion bag (300) comprising a string (310) is placed in the cup (200) and the string (310) is arranged to extend from the infusion bag (300) over the mouth (113) of the chamber (110) and over the rim (240) of the cup. The cup is then substantially filled with liquid (400), such as boiling water. After the desired infusion time, the user draws the infusion bag (300) into the chamber (110) of the attachment by pulling the string (310) away from the body (210) of the cup, without removing the infusion bag (300) from the cup (200). Because the chamber (110) is substantially impermeable to the boiling water, then the infusion process is now completely stopped. This is true even when the container is tilted during drinking because the infusion bag (300) is located in the cavity (112) which is below the mouth (113) of the chamber (110) and the mouth (113) is well above the level of the liquid (400) in the filled cup. Furthermore even when the container is tilted during drinking the beverage bag is held within the chamber and cannot swing or otherwise move to interfere with the drinking process. The hand grip (123) provides a convenient means for holding the container and helps prevent discomfort which may otherwise arise from heat transfer between the hot liquid and the hand of the user through the cup.

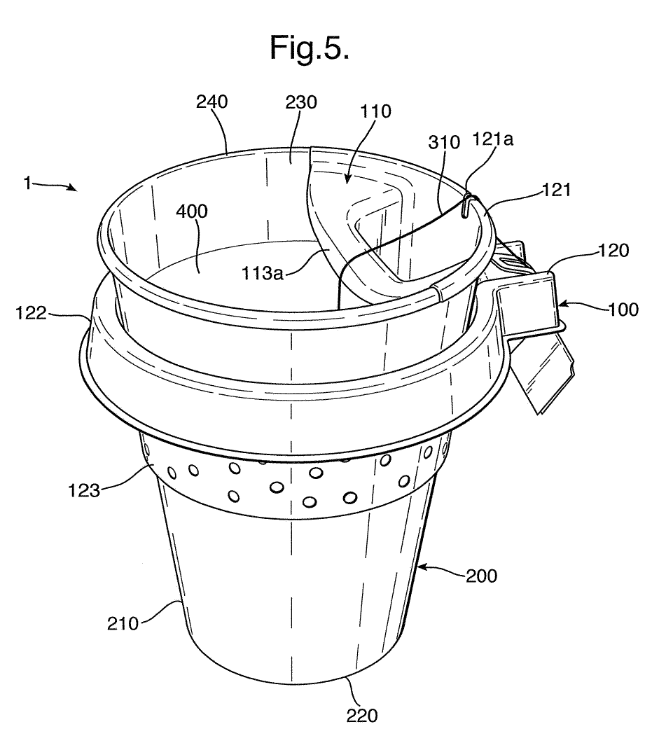

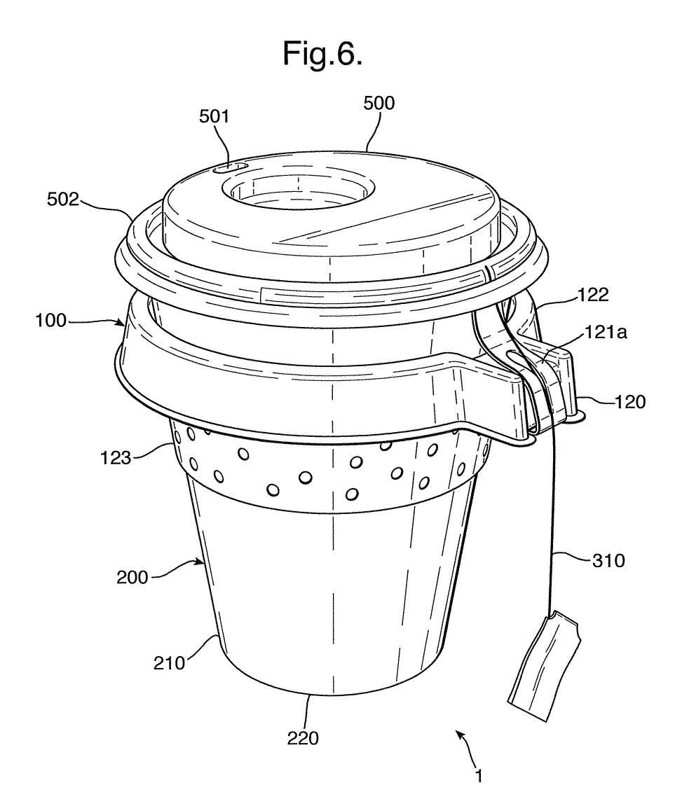

Another embodiment of the invention is shown in FIGS. 5 and 6. Features which are common to this embodiment and the first embodiment described above are labelled with the same reference numerals as used above.

In the container shown in FIG. 5, the first portion (121) of the element (120) has a slit (121a) cut therein which is shaped to allow the string (310) of the infusion bag (300) to slide therethrough. The handgrip (123) of the embodiment shown in FIGS. 5 and 6 is textured with sunken dots to increase grip and aid insulation.

The container shown in FIGS. 5 and 6 may be used in the same way as described for the first embodiment. In addition, however, when the string (310) is arranged to extend from the infusion bag (300) over the mouth (113) of the chamber (110) and over the rim (240) of the cup (200), the length of string which passes over the rim (240) is located in the slit (121a).

As can be seen from FIG. 6, a lid (500) comprising a drinking aperture (501) and a circular flange (502) may be included with the container. The flange (502) forms a tight fit with the rim (240) of the cup to minimise or prevent spillage of liquid (400) from the cup (200). This tight fit is maintained even with the presence of the attachment (100) because of the shape and size of the first portion (121) of the element which does not project more than 2 mm above the rim (240). Furthermore, owing to location of the string (310) in the slit (121a), even with the lid (500) attached to the cup (200), the user may still draw the infusion bag (300) into the chamber (110) of the attachment by pulling the string (310) away from the body (210) of the cup, without removing the infusion bag (300) from the cup (200).

To minimise interference of the spent infusion bag with the drinking process it is preferred that when the lid (500) is positioned to cover the mouth (230) of the cup, the drinking aperture (501) is not located over the chamber (110), more preferably the chamber (310) is located away from the centre of the cup mouth (230) in a first radial direction and the drinking aperture (501) is located away from the centre of the cup mouth (230) in a radial direction substantially opposite to the first radial direction.

1. An attachment (100) for a cup (200) having a body (210), a base (220) and a mouth (230) delimited by a rim (240), the attachment comprising:
a chamber (110) for holding an infusion bag (300) and comprising a wall (111) delimiting a cavity (112) for receiving the infusion bag (300) and a mouth (113) for allowing the infusion bag (300) to pass into the cavity (112); and
an element (120) for suspending the chamber (110) within the cup (200) such that at least a portion of the mouth (113) of the chamber (110) is below the rim (240) of the cup (200);
wherein the element (120) and chamber (110) are arranged such that when the chamber (110) is suspended in the cup (200), liquid (400) cannot pass between the cup and the chamber when the cup is substantially full.

2. An attachment according to claim 1 wherein a first portion (121) of the element extends from the chamber (110) over the rim (240) of the cup.

3. An attachment according to claim 2 wherein the first portion (121) of the element is shaped to pass over the rim (240) of the cup without protruding more than 2 mm above the rim (240).

4. An attachment according to claim 2 wherein the first portion (121) comprises a groove or slit (121a) shaped to allow a string (310) of an infusion bag (300) to slide therethrough.

5. An attachment according to claim 1 wherein the element (120) comprises an annular portion (122) shaped to receive the body (210) of the cup.

6. An attachment according to claim 5 wherein the chamber (110) is hingedly attached to the annular portion (122) of the element.

7. An attachment according to claim 1 wherein the attachment (100) comprises a hand grip (123).

8. An attachment according to claim 7 wherein the hand grip (123) is a section of the annular portion (122) of the element.

9. An attachment according to claim 1 wherein the element (120) and chamber (110) are arranged such that when the chamber (110) is suspended in the cup (200), the wall (111) of the chamber extends substantially vertically downwards from the mouth (113) of the chamber.

10. An attachment according to claim 9 wherein the element (120) and chamber (110) are arranged such that with the chamber (110) suspended in the cup (200) the cavity (112) is below the mouth (113) of the chamber.

11. An attachment according to claim 1 wherein the element (120) and chamber (110) are arranged such that when the chamber (110) is suspended in the cup (200) the liquid (400) is not in contact with the mouth (113) of the chamber when the cup (200) is substantially full.

12. An attachment according to claim 1 wherein the element (120) and chamber (110) are arranged such that when the chamber (110) is suspended in the cup (200) an infusion bag can be passed from the body (210) of the cup (200) into the cavity (112) of the chamber (110) without removing the infusion bag from the cup (200).

13. An attachment according to claim 1 wherein the mouth (113) of the chamber (110) has a lip (113a) which is shaped to allow easy passage of an infusion bag (300) over the lip (113a) and into the cavity (112).

14. A container (1) comprising:
a cup (200) having a body (210), a base (220) and a mouth (230) delimited by a rim (240); and
an attachment (100) as claimed in claim 1;
wherein the chamber (110) of the attachment is suspended within the cup.

15. A container according to claim 14 wherein the container (1) additionally comprises an infusion bag (300) and the infusion bag has a string (310) attached thereto.

16. A container according to claim 15 wherein the infusion bag (300) is within the cup (200) and wherein the string (310) extends from the infusion bag (300) over the mouth (113) of the chamber (110) and over the rim (240) of the cup.

17. A container according to claim 16 arranged such that a user may draw the infusion bag (300) into the chamber (110) of the attachment by pulling the string (310) away from the body (210) of the cup, without removing the infusion bag (300) from the cup (200).

18. A container according to claim 1 additionally comprising a lid (500) covering the mouth (230) of the cup.

19. A container according to claim 18 when dependent on any one of claims 15 to 17 wherein the string (310) does not pass through an aperture in the lid (500).

20. A container according to claim 18 wherein the lid comprises a drinking aperture.
